(19) United States
(12) Patent Application Publication
(10) Pub. No.: US 2026/0288712 A1
(43) Pub. Date: Sep. 24, 2026

(54) AUTONOMOUS DATABASE ARCHITECTURE

(71) Applicant: CenturyLink Intellectual Property LLC, Denver, CO (US)

(72) Inventor: Srikanth Kumar Sridhara, Hyderabad (IN)

(73) Assignee: CenturyLink Intellectual Property LLC, Denver, CO (US)

(21) Appl. No.: 19/188,195

(22) Filed: Apr. 24, 2025

Related U.S. Application Data
(60) Provisional application No. 63/773,724, filed on Mar. 18, 2025.

(51) Int. Cl. G06F 16/2452; G06F 16/22

(52) U.S. Cl. CPC G06F 16/24522; G06F 16/22

(57) ABSTRACT

A database management system may ingest data from external databases, store the data in local databases based on a hybrid database model, and may generate a plurality of database agents for managing the data. When a natural language (“NL”) query for data is received from a requesting device, the database management system may cause a database agent(s) to, for each local database: translate the NL query into a query language (“QL”) query, based on a database QL that is used by that database; send the QL query to that database; receive query results from that database; and send the query results to the database management system, which may receive the query results, translate the query results into an NL response, and send the NL response to the requesting device.

### CROSS-REFERENCES TO RELATED APPLICATIONS

This application claims priority to U.S. Patent Application Ser. No. 63/773,724 (the “'724 Application”), filed Mar. 18, 2025, by Srikanth Kumar Sridhara, entitled, “Autonomous Database Architecture,” and may be related to U.S. Patent Application Ser. No. 63/773,707 (the “'707 Application”), filed Mar. 18, 2025, by Srikanth Kumar Sridhara, entitled, “Database Interface Framework and Database A gents,” and the disclosure of each of which is incorporated herein by reference in its entirety for all purposes.

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing database functionality, and, more particularly, to methods, systems, and apparatuses for implementing an autonomous database architecture and operations of the autonomous database architecture.

### BACKGROUND

Managing modern databases is a complex undertaking, requiring specialized expertise, continuous monitoring, and resource allocation. Traditional database management systems (“DBMSs”) require significant manual intervention for tasks such as query execution, optimization, scaling, security enforcement, and system monitoring. Existing systems are also reactive rather than proactive, often failing to predict and prevent issues before they occur. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing an autonomous database architecture and operations of the autonomous database architecture, in accordance with various embodiments.

FIG. 2 depicts an example sequence flow for implementing autonomous database architecture operations, in accordance with various embodiments.

FIG. 3 depicts a flow diagram illustrating an example method for implementing an autonomous database architecture and operations of the autonomous database architecture, in accordance with various embodiments.

FIG. 4 depicts a flow diagram illustrating another example method for implementing an autonomous database architecture and operations of the autonomous database architecture, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

As briefly discussed above, traditional DBMSs require significant manual intervention for tasks such as query execution, optimization, scaling, security enforcement, and system monitoring. Such existing systems are also reactive rather than proactive, often unable to predict and prevent issues before they occur. Further, traditional DBMSs require individuals with database expertise to effectively query databases.

The present technology provides for an autonomous database architecture and operations of the autonomous database architecture. In examples, the present technology provides an autonomous database system that may utilize agentic artificial intelligence (“AI”) to automate database management operations, in some cases, by integrating intelligent database agents capable of self-learning, decision-making, and seamless interaction with various data environments to ensure optimal performance, security, and scalability. The autonomous database system provides a fully self-governing solution for both structured and unstructured data environments, while minimizing human intervention by leveraging natural language processing (“NLP”), machine learning (“ML”), and multi-agent coordination. With natural language (“NL”) queries as inputs, the autonomous database system enables non-database experts to initiate queries of databases, while enhancing query efficiencies and accuracies, by properly translating the NL queries into database-specific query language (“QL”) queries (particularly where query languages differ amongst different databases). In examples, the autonomous database system may ingest and migrate data stored in external or third party databases into local databases of the autonomous database system, in some cases, using at least one of ingestion tools, pre-processing systems, indexing systems, and/or a hybrid database model(s), and/or the like. The autonomous database system may generate any suitable number of database agents to access data stored in the local databases, in some cases, using the hybrid database model(s). With the ingestion of data and the generation of database agents being internally performed (in some cases, using the same hybrid database model(s), or the like), there is no need for additional systems (e.g., database bots and/or database interface frameworks to be trained to access the data in coordination of database agents, as described in detail in the '707 Application, which has been incorporated herein by reference in its entirety for all purposes).

In the manner above and as described in detail below, the agentic AI-powered autonomous database system enables improvement in reliability, while enhancing scalability and reducing operational costs. For example, predictive capabilities of the agentic AI-powered autonomous database system ensure higher reliability and performance. The agentic AI-powered autonomous database system adapts to dynamic workloads and threats using AI-driven scalability and security. Fully autonomous operations enable the agentic AI-powered autonomous database system to reduce operational costs and human error.

These and other aspects of the autonomous database architecture and the operations of the autonomous database architecture are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including: causing, by a database management system, ingestion of a plurality of data from one or more external databases; storing, by the database management system, the plurality of data in one or more databases based on a hybrid database model; generating, by the database management system, a plurality of database agents based on the hybrid database model, each database agent being configured to access data stored in the one or more databases; receiving, by the database management system and from a requesting device, a first query for accessing first data among the plurality of data stored in the one or more databases, the first query being an NL query; causing, by the database management system, at least one database agent of the plurality of database agents to access the first data from at least one database among the one or more databases, in response to the first query, by causing the at least one database agent to perform operations including, for each of the at least one database: translating the first query into a QL query, from the NL query into a database query language that is used by that database among the at least one database; sending the QL query to that database; receiving query results from that database; and sending the query results to the database management system; receiving, by the database management system, the query results from each of the at least one database, via the at least one database agent; causing, by the database management system, translation of the query results for the at least one database into an NL response; and sending, by the database management system, the NL response to the requesting device.

In another aspect, the technology relates to a system, including a database management system, the database management system executing a first set of computer executable instructions that cause the database management system to perform first operations. The database management system may include a data ingestion layer; a storage layer; an agentic AI layer; and a query interface layer. The first operations may include: causing, using the data ingestion layer, ingestion of a plurality of data from one or more external databases; storing the plurality of data in one or more databases of the storage layer, based on a hybrid database model; generating a plurality of database agents within the agentic AI layer, based on the hybrid database model, each database agent being configured to access data stored in the one or more databases of the storage layer; receiving, using the query interface layer and from a requesting device, a first query for accessing first data among the plurality of data stored in the one or more databases, the first query being an NL query; causing, by the database management system, at least one database agent of the plurality of database agents to access the first data from at least one database among the one or more databases, in response to the first query, wherein each database agent executes a second set of computer executable instructions that cause that database agent to perform second operations. The second operations may include, for each of the at least one database: translating the first query into a QL query, from the NL query into a database query language that is used by that database among the at least one database; sending the QL query to that database; receiving query results from that database; and sending the query results to the database management system. The first operations may further include: receiving the query results from each of the at least one database, via the at least one database agent; causing translation of the query results for the at least one database into an NL response; and sending the NL response to the requesting device.

In yet another aspect, the technology relates to a method, including: receiving, by a database management system and from a requesting device, a first query for accessing first data among a plurality of data that is stored in one or more databases among a plurality of databases, the first query being an NL query, the plurality of databases including a combination of structured and unstructured databases, two or more of the plurality of databases using corresponding two or more query languages that are different from each other; causing, by the database management system, at least one database agent of a plurality of database agents that is generated by the database management system to access the first data from at least one database among the one or more databases, in response to the first query, by causing the at least one database agent to perform operations including, for each of the at least one database: translating the first query into a QL query, from the NL query into a database query language that is used by that database among the at least one database, sending the QL query to that database, receiving query results from that database, and sending the query results to the database management system; receiving, by the database management system, the query results from each of the at least one database, via the at least one database agent; causing, by the database management system, translation of the query results for the at least one database into an NL response; and sending, by the database management system, the NL response to the requesting device.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

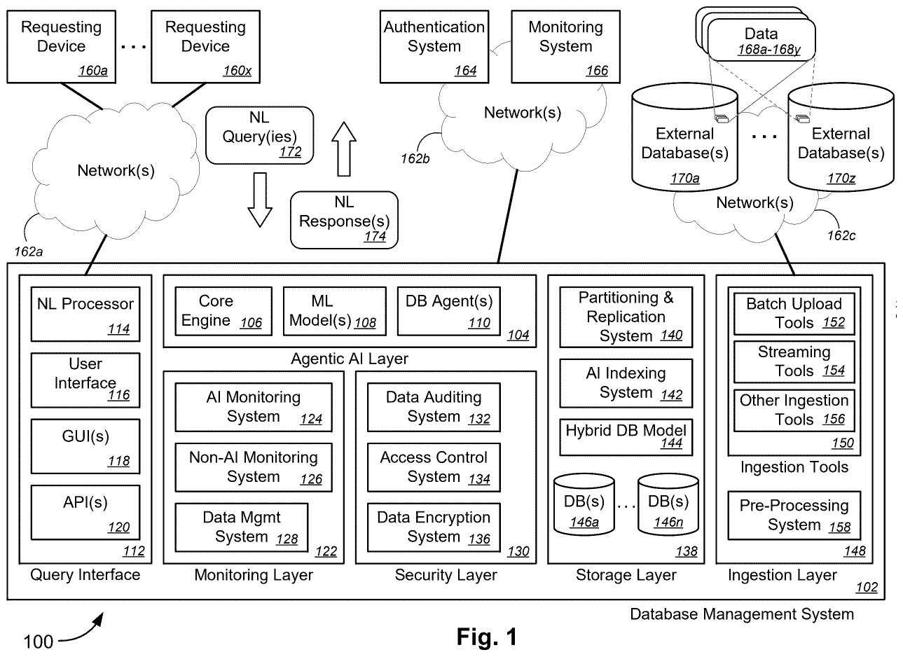

Turning to the embodiments as illustrated by the drawings, FIGS. 1-5 illustrate some of the features of methods, systems, and apparatuses for implementing database functionality, and, more particularly, to methods, systems, and apparatuses for implementing an autonomous database architecture and operations of the autonomous database architecture, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing an autonomous database architecture and operations of the autonomous database architecture, in accordance with various embodiments.

In the non-limiting embodiment of FIG. 1, system 100 may include database management system 102, which may include an agentic AI layer 104. In examples, the agentic Al layer 104 may include at least one of a core engine 106, one or more ML models 108, and/or one or more database agents 110, and/or the like. In some instances, the database management system 102 may further include a query interface 112, which may include at least one of an NL processor 114, a user interface (“UI”) 116, one or more graphical UIs (“GUIs”) 118, and/or one or more application programming interfaces (“APIs”) 120, and/or the like. In some cases, the database management system 102 may further include a monitoring layer 122, which may include at least one of an AI monitoring system 124, a non-AI monitoring system 126, and/or a data management system 128, and/or the like. In examples, the database management system 102 may further include a security layer 130, which may include at least one of a data auditing system 132, an access control system 134, and/or a data encryption system 136, and/or the like. In some examples, the database management system 102 may further include a storage layer 138, which may include at least one of a partitioning and replication system 140, an AI (or AI-based) indexing system 142, a hybrid database model 144, and/or a plurality of databases 146a-146n (collectively, “databases 146” or the like), and/or the like. In some instances, the database management system 102 may further include an ingestion layer 148, which may include ingestion tools 150 including at least one of one or more batch upload tools 152, one or more streaming tools 154, and/or one or more other ingestion tools 156, and/or the like. In some cases, the ingestion layer 148 may also include a pre-processing system 158.

In examples, system 100 may further include a plurality of requesting devices 160a-160x that is associated with a corresponding plurality of users and that communicatively couples with the database management system 102 via network(s) 162a. In some instances, system 100 may further include at least one of an authentication system 164 and/or a monitoring system 166, each of which may communicatively couple with the database management system 102 via network(s) 162b. In some cases, a plurality of data 168a-168y may be stored in a plurality of external databases 170a-170z (collectively, “external databases 170” or “databases 170” or the like), which may communicatively couple with the database management system 102 via network(s) 162c. In some cases, while the plurality of databases 146a-146n may be part of the database management system 102, the plurality of databases 170a-170z may be part of or located within one of a private data environment or a cloud environment, or the like. The plurality of databases 146a-146n (and/or the plurality of databases 170a-170z) may include a combination of structured and unstructured databases, two or more of the plurality of databases using corresponding two or more query languages that are different from each other. As used herein, a structured database may refer to a database or database management system that stores data in a structured format and, in some cases, may use structured query language (“SQL”) for querying and updating the database, or the like, and may include relational databases or relational database management systems (“RDBMSs”). An unstructured database, as used herein, may refer to a database or database management system that stores data without a predefined structure, and may include not-only-SQL (“NoSQL”) databases or NoSQL database management systems, or the like. In examples, the data stored in the structured database or stored in the unstructured database may include at least one of text-based data, image data, audio data, and/or video data, or the like. Herein, n, x, y, and z are non-negative integer numbers that may be either all the same as each other, all different from each other, or some combination of same and different (e.g., one set of two or more having the same values with the others having different values, a plurality of sets of two or more having the same value with the others having different values, etc.).

In some examples, the plurality of requesting devices 160a-160x may each include, but is not limited to, one of a desktop computer, a laptop computer, a tablet computer, a smart phone, a mobile phone, or a server computer, and/or the like. In some cases, a user of the requesting devices 160 may include a user among a range of user groups within an organization, as well as external customers, depending on use case. In examples, the user groups may include non-technical business users, customer support team members, information technology (“IT”) and database administrators, data analysts and managers, and/or external customers or end-users, or the like. In some instances, non-technical business users may include sales, marketing, and/or operations teams, who often require access to data insights, but may not have technical expertise. The database management system 102 and/or the agentic AI layer 104 may allow such users to easily retrieve customer data, analyze sales trends, and/or monitor key metrics, and/or the like. In some cases, non-technical business users may alternatively include executives and/or decision-makers, or the like. The database management system 102 and/or the agentic AI layer 104 may provide such leaders with immediate access to data insights, enabling faster, data-driven decision-making without having to wait for reports from data teams.

In examples, customer support team members may include customer support representatives who can use the database management system 102 and/or the agentic AI layer 104 to quickly retrieve customer account information and/or purchase histories, and to resolve customer inquiries more efficiently. By offering real-time responses, the database management system 102 and/or the agentic AI layer 104 may help support teams provide faster, more informed customer service, enhancing the overall customer experience. In some examples, while the database management system 102 and/or the agentic AI layer 104 may be intended to minimize dependence on IT for basic queries, IT and database administrators can use the database management system 102 and/or the agentic AI layer 104 as a tool to reduce routine support requests, allowing them to focus on higher-level tasks. In examples, the database management system 102 and/or the agentic AI layer 104 may also serve as an internal tool for IT administrators to monitor database health or log system usage metrics, helping them maintain performance and security. In some cases, data analysts and managers can use the database management system 102 and/or the agentic AI layer 104 as a quick reference tool for accessing certain datasets or verifying data points without needing to manually query the database. The database management system 102 and/or the agentic AI layer 104 can also aid data managers by generating automated reports or alerts, ensuring they have up-to-date information at hand without running frequent manual reports. In some instances, in customer-facing use cases, the database management system 102 and/or the agentic AI layer 104 can serve as a virtual assistant for end-users, allowing customers to self-serve for information about their accounts, usage, or transactions. The database management system 102 and/or the agentic AI layer 104 can enhance customer satisfaction by reducing wait times and empowering customers to access their own data whenever they need it.

According to some embodiments, unless otherwise indicated, networks 162a-162c may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™M protocol known in the art, and/or any other wireless protocol; and/or any combination of these and/or other networks. In a particular embodiment, the networks 162a-162c may include an access network of the service provider (e.g., an Internet service provider (“ISP”)). In another embodiment, the networks 162a-162c may include a core network of the service provider and/or the Internet.

In an aspect, database management system 102 may ingest a plurality of data (e.g., data 168a-168y) that is stored in one or more external databases (e.g., external databases 170a-170z), in some cases, using the ingestion tools 150 and the pre-processing system 158 of ingestion layer 148. In an example, the one or more batch upload tools 152 enable ingestion of multiple data from the one or more external databases 170a-170z into the plurality of databases 146a-146n, via network(s) 162c, in batches of data. In some cases, the one or more streaming tools 154 enable streaming of data from the one or more external databases 170a-170z into the plurality of databases 146a-146n, via network(s) 162c. In some instances, the one or more other ingestion tools 156 may include at least one of a data migration tool, a data uploading tool, or a data synchronization tool, and/or the like, that performs corresponding at least one of migrating data from the one or more external databases 170a-170z into the plurality of databases 146a-146n (via network(s) 162c), uploading individual data files from the one or more external databases 170a-170z into the plurality of databases 146a-146n (via network(s) 162c), or synchronizing data stored in the plurality of databases 146a-146n with corresponding data stored in the one or more external databases 170a-170z, and/or the like. In some cases, the pre-processing system 158 may pre-process the data that is ingested from the external databases 170a-170z, prior to storage of the data in the databases 146a-146n in the storage layer 138.

In examples, the database management system may store the data (whether or not pre-processed by the pre-processing system 158) in the one or more databases 146a-146n in the storage layer 138, based on hybrid database model 144. In some instances, the database management system, using the partitioning and replication system 140, may partition one or more of the databases 146 as necessary during the ingestion and storage phase, in some cases, replicating partitions and/or data. In some cases, the database management system, using the AI indexing system 142, may perform indexing of the plurality of data stored in the one or more databases 146a-146n to produce or update a database index. In some examples, because the plurality of databases 146a-146n may include a combination of structured and unstructured databases, the database indexing assists in identifying location of stored data within the databases, particularly where some databases do not have built-in index functionality. In some instances, during operation, with the database index being produced or updated, at least one database agent 110 may check the database index to determine whether and which of the one or more databases 146a-146n contain data in queries.

In some examples, the database management system may perform one or more security functions and/or one or more database features. In examples, the one or more database security functions may include at least one of data auditing, data access control, or data encryption, and/or the like, using corresponding at least one of data auditing system 132, access control system 134, or data encryption system 136, and/or the like. In some cases, the database security functions may be performed using one or more monitoring and maintenance systems including monitoring layer 122, AI monitoring system 124, non-AI monitoring system 126, data management system 128, data auditing system 132, access control system 134, data encryption system 136, and/or monitoring systems 166. In some instances, the database security functions may be performed using AI monitoring system 124, non-AI monitoring system 126, and/or data update systems (e.g., data management system 128, or the like), and/or the like. In some examples, the one or more database features may include at least one of database self-healing, database self-optimization, query translation, or data pattern analysis, and/or the like. In some instances, the one or more database features may be performed using one or more ML models 108 that may be trained to perform at least one of predictive analytics, data clustering, or time-series forecasting, and/or the like.

In examples, the database management system 102 may generate a plurality of database agents 110 based on the hybrid database model 144, each database agent being configured to access data stored in the one or more databases 146a-146n. In some examples, generating the plurality of database agents 110 may include the database management system 102: (1) determining at least one of a number or configurations of database(s) agents 110, based on the hybrid database model 144; and (2) generating the plurality of database agents 110 based on the determined at least one of a number of database(s) agents 110 or configurations of database(s) agents 110, and based on the hybrid database model 144; and/or the like. In some cases, the at least one of the number or the configurations of the database(s) agents may be determined using an AI system (e.g., agentic AI layer 104 or core engine 106 running ML model(s) 108, or the like).

In some aspects, a requesting device 160 among the plurality of requesting devices 160a-160x may send an NL query(ies) 172 to database management system 102 via network(s) 162a. In some examples, the database management system 102, using query interface 112 (including user interface 116, GUI(s) 118, or the like), may receive the NL query(ies) 172, in some cases, via at least one of an interface connector, an API, or a portal, and/or the like. In examples, the NL query(ies) 180 may include at least one of a text-based NL query, a chat-based NL query, a search engine-based NL query, an email-based NL query, a voice-based NL query, or a video-based NL query, and/or the like. In some cases, the database management system 102, using authentication system 164 via network(s) 162b, may authenticate the requesting device 160 and/or the user associated with the requesting device 160. In the case the authentication fails, the requesting device 160 and/or the user would be blocked from accessing data stored in the databases 146a-146n. On the other hand, after the requesting device 160 and/or the user has been successfully authenticated, the database management system 102 and/or the agentic AI layer 104 may initiate processes for accessing data stored in the database(s) 146a-146n, in response to the NL query(ies) 172, as described in detail below.

In examples, the database management system 102 and/or the agentic AI layer 104 may cause translation of the NL query(ies) 172 into at least one of a database agent query or a QL query (in some cases, using NL processor 114), from the natural language of the NL query(ies) 172 to a corresponding one of a database agent QL that is used by the database agent 110 or at least one database QL that is used by each of corresponding at least one database 146 among the plurality of databases 146a-146n. In some instances, the database management system 102 and/or the agentic AI layer 104 may send the database agent query to the database agent(s) 110 or may cause the database agent(s) 110 to send the QL query to the database 146 among the plurality of databases 146a-146n. In some cases, the database agent QL may be different from the two or more query languages that are used by two or more of the plurality of databases 146a-146n. In some examples, the database agent 110 may access data stored in at least one database among the plurality of databases 146a-146n, by, for each of the at least one database: (a) translating the database agent query or the NL query(ies) 172 into a QL query(ies), from the database agent QL or the NL into a database QL that is used by that database among the at least one database 146; (b) sending the QL query(ies) to that database; (c) receiving QL response(s) or query results from that database; and (d) sending the QL response(s) to the database management system 102 and/or the agentic AI layer 104. The database management system 102 and/or the agentic AI layer 104 may receive the QL response(s) from each of the at least one database 146, via the database agent(s) 110. The database management system 102 and/or the agentic AI layer 104 may cause translation of the QL response(s) for the at least one database into an NL response(s) 174 (in some cases, using NL processor 114), and may send the NL response(s) 174 to the requesting device 160, via query interface 112 and network(s) 162a.

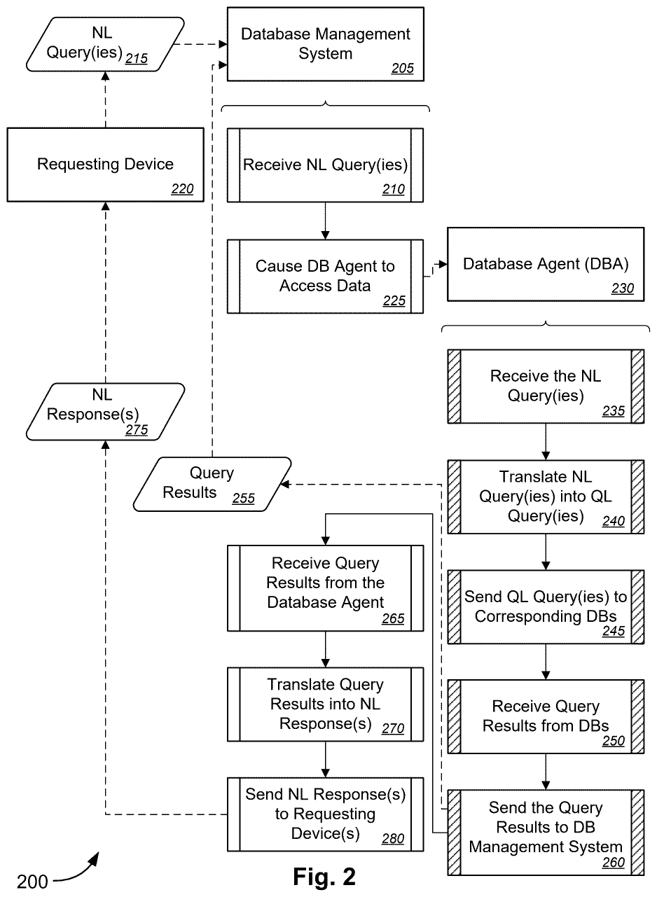

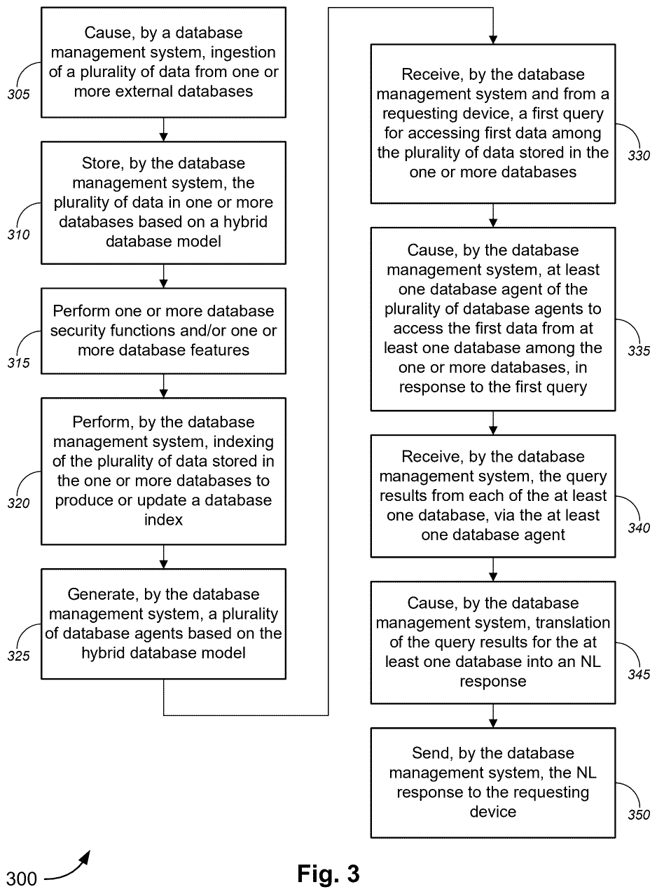

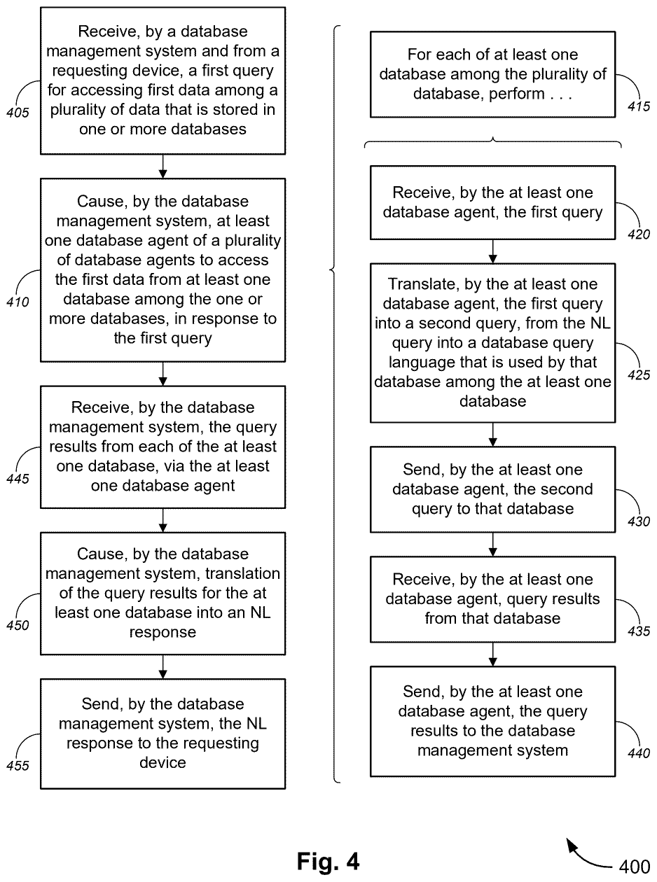

In operation, database management system 102 and/or database agent(s) 110 may perform methods for implementing the autonomous database architecture and the operations of the autonomous database architecture, as described in detail with respect to FIGS. 2-4. For example, example sequence flow 200 as described below with respect to FIG. 2, and methods 300 and 400 as described below with respect to FIGS. 3 and 4 may be applied with respect to the operations of system 100 of FIG. 1.

In various aspects, an autonomous database system is provided that may utilize agentic AI (e.g., agentic AI layer 104, or the like) to automate database management operations, in some cases, by integrating intelligent database agents (e.g., database agent(s) 110, in some instances, powered by AI systems running ML model(s) 108, or the like) capable of self-learning, decision-making, and seamless interaction with various data environments to ensure optimal performance, security, and scalability. The autonomous database system minimizes human intervention by leveraging NLP, ML, and multi-agent coordination. In examples, the agentic AI layer 104 may include features or functionalities including, but not limited to, at least one of self-learning capabilities (e.g., using core engine 106 and/or ML model(s) 108, or the like), an NL interface (e.g., query interface 112 and/or components thereof including NL processor 114, UI 116, GUI(s) 118, and/or the like API(s) 120, or the like), a multi-agent architecture, proactive decision-making, or security and compliance, and/or the like. In some cases, the agentic AI layer 104 may be used to optimize operations by using self-learning capabilities to perform continuous analysis of historical data and real-time performance metrics that may be collected or monitored using monitoring layer 122 and/or components thereof (e.g., AI monitoring system 124, non-AI monitoring system 126, or the like), and to perform adaptive query optimization using ML algorithms, or the like. Alternatively or additionally, in some instances, the agentic AI layer 104 may translate user input into system-understandable commands by using a conversational interface powered by NLP (e.g., using NL processor 114, or the like). Alternatively or additionally, in some examples, the agentic AI layer 104 may utilize agents with specialized roles (e.g., performance monitoring, security management, data integrity, and/or the like) that collaborate seamlessly with each other. Alternatively or additionally, in examples, the agentic AI layer 104 may predict issues, may identify solutions to potential issues as predicted, and may preemptively address the potential issues, using proactive decision-making and predictive maintenance functionalities (e.g., using core engine 106, ML model(s) 108, and/or data management system 128, or the like). Alternatively or additionally, in some cases, the agentic AI layer 104 may utilize AI-driven monitoring (e.g., monitoring layer 122, AI monitoring system 124, data management system 128, security layer 130, data auditing system 132, access control system 134, and/or data encryption system 136, or the like) to autonomously enforce security policies and compliance requirements.

The agentic AI-powered autonomous database system enables full autonomy, with features including at least one of database self-configuration, database self-healing, database self-optimization, and/or database self-protection, and/or the like, thereby minimizing the need for human interaction. The agentic AI-powered autonomous database system is database agnostic, being compatible with structured databases (e.g., relational databases or RDBMSs, such as databases using SQL, or the like) as well as unstructured databases (e.g., NoSQL databases or NoSQL database management systems, or the like). The agentic AI-powered autonomous database system provides for high scalability, by using dynamic resource allocation to manage large datasets efficiently. In some examples, the agentic AI-powered autonomous database system enables multi-platform support that provides functionality across different environments including on-premises, cloud, and/or hybrid environments, or the like. In examples, the agentic AI-powered autonomous database system enables Enterprise data management with minimal overhead. In some cases, the agentic AI-powered autonomous database system provides real-time analytics and insights for business intelligence. Alternatively or additionally, in some instances, the agentic Al powered autonomous database system enables secure and compliant data handling for industries including healthcare, finance, and/or the like. In some cases, the agentic AI-powered autonomous database system may be deployed using scalable cloud infrastructure. In the manner above, by leveraging agentic AI, the system provides a robust, scalable, and intelligent solution to the challenges of modern data environments.

Further, by ingesting and migrating data from external database(s) 170a-170z (which may be managed by one or more third party entities with one or more different database models, or the like), and storing the data in the hybrid database model 144 within databases 146a-146n of the storage layer 138, the agentic AI layer is already familiar with the hybrid database model 144 and can create or generate any suitable number of database agents 110 to access the data stored in the hybrid database model 144 within databases 146a-146n of the storage layer 138. In this manner, it is not necessary for a database bot of a database interface framework and/or database agents to be trained to access data (by translating NL query(ies) into database agent QL and determined QLs) from external databases, as described in detail in the '707 Application, which has been incorporated herein by reference in its entirety for all purposes, and which is directed to embodiments in which data is not ingested or migrated into local databases as described in detail herein.

FIG. 2 depicts an example sequence flow 200 for implementing autonomous database architecture operations, in accordance with various embodiments. In some embodiments, database management system 205, NL query(ies) 215, requesting device 220, database agent 230, and NL response(s) 275 of FIG. 2 may be similar, if not identical, to the database management system 102, NL query(ies) 172, requesting devices 160a-160x, and database agent(s) 110, respectively, of system 100 of FIG. 1, and the description of these components of system 100 of FIG. 1 are similarly applicable to the corresponding components of FIG. 2. In FIG. 2, solid lined arrows from one process block to another (e.g., among process blocks 210, 225, 235-250, 260-270, and 280) correspond to the operations that are part of example sequence flow 200, where process blocks with blank side portions correspond to operations performed by the database management system 205 (e.g., operations 210, 225, 265, 270, and 280), while the process blocks with shaded side portions correspond to operations performed by the database agent 230 (e.g., operations 235, 240, 245, 250, and 260). Further in FIG. 2, the dash-lined arrows are associated with queries or results/responses being sent to or from devices (e.g., database management system 205, requesting device 220, and database agent 230).

With reference to FIG. 2, example sequence flow 200 may include database management system 205 receiving, at operation 210, NL query(ies) 215 from requesting device 220 (as depicted in FIG. 2 by the dash-lined arrows from the requesting device 220 to the database management system 205). At operation 225, the database management system 205 may cause a database agent 230 to access data as indicated in the NL query(ies) 215. In some examples, causing the database agent 230 to access the data may include translating the NL query(ies) 215 into database agent (“DBA”) QL query(ies), which is in a query language that is used by the database agent 230, and sending the DBA QL query(ies) to the database agent 230.

At operation 235, the database agent 230 may receive the NL query(ies) 215 (and/or the DBA QL query(ies)). At operation 240, the database agent 230 may translate the NL query(ies) 215 (and/or the DBA QL query(ies)) into QL query(ies), each QL query(ies) being in a query language, among a plurality of query languages, that is used by a database, among one or more databases, to which that QL query(ies) is to be sent, and may send that QL query(ies) to that database (at operation 245). At operation 250, the database agent 230 may receive query results 255 from the one or more databases. At operation 260, the database agent 230 may send the query results 255 to the database management system 205 (as depicted in FIG. 2 by the dash-lined arrows from the process block for operation 260 to the database management system 205). In an example, the database agent 230 may receive query results 255 from each of the one or more databases prior to sending all the received query results 255 (in some cases, either compiling the query results 255 in a single file for sending to the database management system 205, or sending the individual query results 255 to the database management system 205). Alternatively, in another example, the database agent 230 may send query results 255 from each of the one or more databases as they are received, with the database management system 205 collecting and compiling the query results 255 from each of the at least one database after all have been received.

At operation 265, the database management system 205 may receive the query results 255 from the database agent 230. At operation 270, the database management system 205 may translate the query results into NL response(s) 275. At operation 280, the database management system 205 may send the NL response(s) 275 to the requesting device 220 (as depicted in FIG. 2 by the dash-lined arrows from the process block for operation 280 to the requesting device 220).

FIG. 3 depicts a flow diagram illustrating an example method 300 for implementing an autonomous database architecture and operations of the autonomous database architecture, in accordance with various embodiments. With reference to FIG. 3, the operations of example method 300 may be performed by a database management system (e.g., database management system 102 or 205 of FIG. 1 or 2, or the like), or components thereof, and/or a database agent (e.g., database agent(s) 110 or 230 of FIG. 1 or 2, or the like).

In the example method 300 of FIG. 3, at operation 305, a database management system may cause ingestion of a plurality of data (e.g., data 168a-168y of FIG. 1, or the like) from one or more external databases (e.g., external databases 170a-170z of FIG. 1, or the like). In examples, the ingestion of the plurality of data from the one or more external databases may be performed using one or more data ingestion tools (e.g., ingestion layer 148 and/or ingestion tools 150 of FIG. 1, or the like). In some cases, the one or more data ingestion tools may include at least one of a batch uploading tool (e.g., batch upload tools 152 of FIG. 1, or the like), a real-time streaming tool (e.g., streaming tools 154 of FIG. 1, or the like), a pre-processing tool (e.g., pre-processing system 158 of FIG. 1, or the like), or other ingestion tools (e.g., other ingestion tools 156 of FIG. 1, or the like), and/or the like. At operation 310, the database management system may store the plurality of data in one or more databases (e.g., storage layer 138 and/or databases 146a-146n of FIG. 1, or the like), based on a hybrid database model (e.g., hybrid database model 144 of FIG. 1, or the like). In some instances, the one or more databases (and/or the one or more external databases) may include a plurality of databases including a combination of structured and unstructured databases. In some cases, two or more of the plurality of databases may use corresponding two or more query languages that are different from each other.

In some examples, at operation 315, the database management system may perform one or more security functions and/or one or more database features. In examples, the one or more database security functions may include at least one of data auditing, data access control, or data encryption, and/or the like. In some cases, the database security functions may be performed using one or more monitoring and maintenance systems (e.g., monitoring layer 122, AI monitoring system 124, non-AI monitoring system 126, data management system 128, data auditing system 132, access control system 134, data encryption system 136, and/or monitoring systems 166 of FIG. 1, or the like). In some instances, the database security functions may be performed using AI or ML-based monitoring systems (e.g., AI monitoring system 124 of FIG. 1, or the like), non-AI or ML-based monitoring systems (e.g., non-AI monitoring system 126 of FIG. 1, or the like), and/or data update systems (e.g., data management system 128 of FIG. 1, or the like), and/or the like. In some examples, the one or more database features may include at least one of database self-healing, database self-optimization, query translation, or data pattern analysis, and/or the like. In some instances, the one or more database features may be performed using one or more ML models (e.g., e.g., ML model(s) 108 of FIG. 1, or the like) that may be trained to perform at least one of predictive analytics, data clustering, or time-series forecasting, and/or the like.

In examples, at operation 320, the database management system may perform indexing of the plurality of data stored in the one or more databases to produce or update a database index, in some cases, using an indexing system. In some examples, the indexing of the plurality of data may be performed using AI-based indexing system (e.g., AI indexing system 142 of FIG. 1, or the like). In some instances, during operation, with the database index being produced or updated, at least one database agent may check the database index to determine whether and which of the one or more databases contain data in queries.

At operation 325, the database management system may generate a plurality of database agents (e.g., database agent(s) 110 of FIG. 1, or the like) based on the hybrid database model, each database agent being configured to access data stored in the one or more databases. In some examples, generating the plurality of database agents (at operation 325) may include the database management system: (1) determining at least one of a number or configurations of database(s) agents, based on the hybrid database model; and (2) generating the plurality of database agents based on the determined at least one of a number of database(s) agents or configurations of database(s) agents, and based on the hybrid database model. In some cases, the at least one of the number or the configurations of the database(s) agents may be determined using an AI system.

At operation 330, the database management system may receive, from a requesting device (e.g., one of requesting devices 160a-160x or requesting device 220 of FIG. 1 or 2, or the like), a first query for accessing first data among the plurality of data stored in the one or more databases. The first query may be an NL query (e.g., NL query(ies) 172 or 215 of FIG. 1 or 2, or the like). In examples, the first query may include at least one of a text-based NL query, a chat-based NL query, a search engine-based NL query, an email-based NL query, a voice-based NL query, or a video-based NL query, and/or the like. In some instances, the first query may be received from the requesting device via a query interface (e.g., query interface 112 of FIG. 1, or the like). In some cases, the query interface may include at least one of an interactive UI (e.g., UI 116 of FIG. 1, or the like), a GUI (e.g., GUI(s) 118 of FIG. 1, or the like), an API (e.g., API(s) 120 of FIG. 1, or the like), a portal, one or more third party tools, one or more cloud services, or one or more edge computing systems, and/or the like.

At operation 335, the database management system may cause at least one database agent of the plurality of database agents to access the first data from at least one database among the one or more databases, in response to the first query. At operation 340, the database management system may receive the query results from each of the at least one database, via the at least one database agent. The database management system may cause translation of the query results for the at least one database into an NL response (at operation 345), and may send the NL response to the requesting device (at operation 350).

FIG. 4 depicts flow diagrams illustrating another example method 400 for implementing an autonomous database architecture and operations of the autonomous database architecture, in accordance with various embodiments. Referring to FIG. 4, the operations of example method 400 may be performed by a database management system (e.g., database management system 102 or 205 of FIG. 1 or 2, or the like), or components thereof, and/or a database agent (e.g., database agent(s) 110 or 230 of FIG. 1 or 2, or the like).

In the example method 400 of FIG. 4, at operation 405, a database management system may receive, from a requesting device (e.g., one of requesting devices 160a-160x or requesting device 220 of FIG. 1 or 2, or the like), a first query for accessing first data among a plurality of data stored in one or more databases (e.g., storage layer 138 and/or databases 146a-146n of FIG. 1, or the like). The first query may be an NL query (e.g., NL query(ies) 172 or 215 of FIG. 1 or 2, or the like). In examples, the first query may include at least one of a text-based NL query, a chat-based NL query, a search engine-based NL query, an email-based NL query, a voice-based NL query, or a video-based NL query, and/or the like. In some instances, the first query may be received from the requesting device via a query interface (e.g., query interface 112 of FIG. 1, or the like). In some cases, the query interface may include at least one of an interactive UI (e.g., UI 116 of FIG. 1, or the like), a GUI (e.g., GUI(s) 118 of FIG. 1, or the like), an API (e.g., API(s) 120 of FIG. 1, or the like), a portal, one or more third party tools, one or more cloud services, or one or more edge computing systems, and/or the like.

At operation 410, the database management system may cause at least one database agent of the plurality of database agents to access the first data from at least one database among the one or more databases, in response to the first query. In some examples, the database management system may cause the at least one database agent to perform operations including, for each of the at least one database (at operation 415): (a) receiving the first query (at operation 420); (b) translating the first query into a second query (e.g., a QL query), from the NL query into a database query language that is used by that database among the at least one database (at operation 425); (c) sending the second query to that database (at operation 430); (d) receiving query results from that database (at operation 435); and (e) sending the query results to the database management system (at operation 440).

At operation 445, the database management system may receive the query results from each of the at least one database, via the at least one database agent. The database management system may cause translation of the query results for the at least one database into an NL response (at operation 450), and may send the NL response to the requesting device (at operation 455).

While the techniques and procedures in methods 300, 400 are depicted and/or described in a certain order for purposes of illustration, it should be appreciated that certain procedures may be reordered and/or omitted within the scope of various embodiments. Moreover, while the methods 300, 400 may be implemented by or with (and, in some cases, are described below with respect to) the systems, examples, or embodiments 100 and 200 of FIGS. 1 and 2, respectively (or components thereof), such methods may also be implemented using any suitable hardware (or software) implementation. Similarly, while each of the systems, examples, or embodiments 100 and 200 of FIGS. 1 and 2, respectively (or components thereof), can operate according to the methods 300, 400 (e.g., by executing instructions embodied on a computer readable medium), the systems, examples, or embodiments 100 and 200 of FIGS. 1 and 2 can each also operate according to other modes of operation and/or perform other suitable procedures.

### Exemplary System and Hardware Implementation

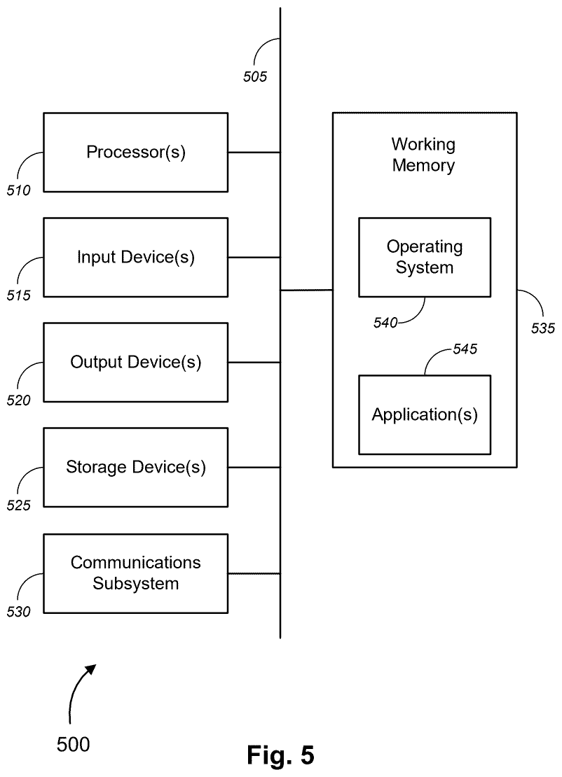

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., database management system 102, agentic AI layer 104, core engine 106, query interface 112, NL processor 114, monitoring layer 122, AI monitoring system 124, non-AI monitoring system 126, data management system 128, security layer 130, data auditing system 132, access control system 134, data encryption system 136, storage layer 138, partitioning and replication system 140, AI indexing system 142, ingestion layer 148, ingestion tools 150, pre-processing system 158, requesting devices 160a-160x, authentication system 164, and monitoring system 166, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., database management system 102, agentic AI layer 104, core engine 106, query interface 112, NL processor 114, monitoring layer 122, AI monitoring system 124, non-AI monitoring system 126, data management system 128, security layer 130, data auditing system 132, access control system 134, data encryption system 136, storage layer 138, partitioning and replication system 140, AI indexing system 142, ingestion layer 148, ingestion tools 150, pre-processing system 158, requesting devices 160a-160x, authentication system 164, and monitoring system 166, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™M device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with-or without certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

1. A method, comprising:
causing, by a database management system, ingestion of a plurality of data from one or more external databases;
storing, by the database management system, the plurality of data in one or more databases based on a hybrid database model, wherein the one or more databases includes a combination of structured and unstructured databases in accordance with the hybrid database model;
generating, by the database management system, a plurality of database agents based on the hybrid database model, each database agent being configured to access data stored in the one or more databases;
receiving, by the database management system and from a requesting device, a first query for accessing first data among the plurality of data stored in the one or more databases, the first query being a natural language (“NL”) query;
causing, by the database management system, at least one database agent of the plurality of database agents to access the first data from at least one database among the one or more databases, in response to the first query, by causing the at least one database agent to perform operations including, for each of the at least one database:
translating the first query into a query language (“QL”) query, from the NL query into a database query language that is used by the at least one database;
sending the QL query to the at least one database;
receiving query results from the at least one database; and
sending the query results to the database management system;
receiving, by the database management system, the query results from each of the at least one database, via the at least one database agent;
causing, by the database management system, translation of the query results for the at least one database into an NL response; and
sending, by the database management system, the NL response to the requesting device.

2. The method of claim 1, wherein the ingestion of the plurality of data from the one or more external databases are performed using one or more data ingestion tools including at least one of a batch uploading tool, a real-time streaming tool, or a pre-processing tool.

3. The method of claim 1, further comprising:
performing one or more database security functions including at least one of data auditing, data access control, or data encryption, wherein the data auditing is performed using one or more monitoring and maintenance systems.

4. The method of claim 3, wherein the one or more monitoring and maintenance systems include at least one of artificial intelligence (“AI”) or machine learning (“ML”)-based monitoring systems, non-AI or ML-based monitoring systems, or data update systems.

5. The method of claim 1, wherein the one or more databases include a plurality of databases including a combination of structured and unstructured databases, two or more of the plurality of databases using corresponding two or more query languages that are different from each other.

6. The method of claim 1, further comprising:
performing, by the database management system, indexing of the plurality of data stored in the one or more databases to produce or update a database index;
wherein the operations performed by the at least one database agent further includes:
checking the database index to determine whether and which of the one or more databases contain the first data;
wherein the at least one database is determined to contain the first data.

7. The method of claim 6, wherein the indexing of the plurality of data is performed using AI-based indexing system.

8. The method of claim 1, wherein the first query includes at least one of a text-based NL query, a chat-based NL query, a search engine-based NL query, an email-based NL query, a voice-based NL query, or a video-based NL query, wherein the first query is received from the requesting device via at least one of an interactive user interface (“UI”), a graphical UI (“GUI”), an application programming interface (“API”), a portal, one or more third party tools, one or more cloud services, or one or more edge computing systems.

9. The method of claim 1, wherein the operations further include:
performing one or more database features including at least one of database self-healing, database self-optimization, query translation, or data pattern analysis.

10. The method of claim 9, wherein the one or more database features are performed using one or more ML models that are trained to perform at least one of predictive analytics, data clustering, or time-series forecasting.

11. The method of claim 1, wherein generating the plurality of database agents comprises:
determining, by the database management system, at least one of a number or configurations of database(s) agents, based on the hybrid database model; and
generating, by the database management system, the plurality of database agents based on the determined at least one of a number of database(s) agents or configurations of database(s) agents, and based on the hybrid database model.

12. The method of claim 11, wherein the at least one of the number or the configurations of the database(s) agents is determined using an AI system.

13. A system, comprising:
a database management system, the database management system including a non-transitory computer-readable medium storing a first set of computer executable instructions, the database management system executing the first set of computer executable instructions that cause the database management system to perform first operations, the database management system comprising:
a data ingestion layer;
a storage layer;
an agentic artificial intelligence (“AI”) layer; and
a query interface layer;
wherein the first operations comprise:
causing, using the data ingestion layer, ingestion of a plurality of data from one or more external databases;
storing the plurality of data in one or more databases of the storage layer, based on a hybrid database model, wherein the one or more databases includes a combination of structured and unstructured databases in accordance with the hybrid database model;
generating a plurality of database agents within the agentic AI layer, based on the hybrid database model, each database agent being configured to access data stored in the one or more databases of the storage layer;
receiving, using the query interface layer and from a requesting device, a first query for accessing first data among the plurality of data stored in the one or more databases, the first query being a natural language (“NL”) query;
causing, by the database management system, at least one database agent of the plurality of database agents to access the first data from at least one database among the one or more databases, in response to the first query, wherein each database agent executes a second set of computer executable instructions that cause that database agent to perform second operations;
wherein the second operations comprise, for each of the at least one database:
translating the first query into a query language (“QL”) query, from the NL query into a database query language that is used by the at least one database;
sending the QL query to the at least one database;
receiving query results from the at least one database; and
sending the query results to the database management system;
wherein the first operations further comprise:
receiving the query results from each of the at least one database, via the at least one database agent;
causing translation of the query results for the at least one database into an NL response; and
sending the NL response to the requesting device.

14. The system of claim 13,
wherein the first operations further comprise:
performing, by the database management system, indexing of the plurality of data stored in the one or more databases to produce or update a database index;
wherein the second operations further comprise:
checking the database index to determine whether and which of the one or more databases contain the first data;
wherein the at least one database is determined to contain the first data.

15. The system of claim 13, wherein the second operations further comprise:
performing one or more database features including at least one of database self-healing, database self-optimization, query translation, or data pattern analysis, using one or more ML models that are trained to perform at least one of predictive analytics, data clustering, or time-series forecasting.

16. A method, comprising:
receiving, by a database management system and from a requesting device, a first query for accessing first data among a plurality of data that is stored in one or more databases among a plurality of databases, the first query being a natural language (“NL”) query, the plurality of databases including a combination of structured and unstructured databases in accordance with a hybrid database model, two or more of the plurality of databases using corresponding two or more query languages that are different from each other;
causing, by the database management system, at least one database agent of a plurality of database agents that is generated by the database management system to access the first data from at least one database among the one or more databases, in response to the first query, by causing the at least one database agent to perform operations including, for each of the at least one database:
translating the first query into a query language (“QL”) query, from the NL query into a database query language that is used by the at least one database;
sending the QL query to the at least one database;
receiving query results from the at least one database; and
sending the query results to the database management system;
receiving, by the database management system, the query results from each of the at least one database, via the at least one database agent;
causing, by the database management system, translation of the query results for the at least one database into an NL response; and
sending, by the database management system, the NL response to the requesting device.

17. The method of claim 16, further comprising:
causing, by the database management system, ingestion of the plurality of data from one or more external databases;
storing, by the database management system, the plurality of data in one or more databases based on the hybrid database model; and
performing, by the database management system, indexing of the plurality of data stored in the one or more databases to produce or update a database index;
wherein the operations performed by the at least one database agent further includes:
checking the database index to determine whether and which of the one or more databases contain the first data;
wherein the at least one database is determined to contain the first data.

18. The method of claim 17, wherein the indexing of the plurality of data is performed using AI-based indexing system.

19. The method of claim 17, further comprising:
generating, by the database management system, the plurality of database agents based on the hybrid database model, each database agent being configured to access data stored in the one or more databases.

20. The method of claim 19, wherein generating the plurality of database agents comprises:
determining, by the database management system and using an AI system, at least one of a number or configurations of database(s) agents, based on the hybrid database model; and
generating, by the database management system, the plurality of database agents based on the determined at least one of a number of database(s) agents or configurations of database(s) agents, and based on the hybrid database model.
